(19) United States
(12) Patent Application Publication
(10) Pub. No.: US 2023/0259394 A1
(43) Pub. Date: Aug. 17, 2023

(54) REPURPOSING ELECTRONIC APPARATUS FOR ALTERNATE RESOURCE EVENT CHANNELS

(71) Applicant: BANK OF AMERICA CORPORATION, Charlotte, NC (US)

(72) Inventors: Paul Martin Mattison, Sherrills Ford, NC (US); Charles Hector Gruesbeck, II, Mint Hill, NC (US); Martha Sain McClellan, Lancaster, SC (US); David Smiddy, Chadds Ford, PA (US); Ann Ta, Scottsdale, AZ (US)

(73) Assignee: BANK OF AMERICA CORPORATION, Charlotte, NC (US)

(21) Appl. No.: 17/584,782

(22) Filed: Jan. 26, 2022

(51) Int. Cl. G06F 9/50; G06F 9/54

(52) U.S. Cl. CPC G06F 9/5005; G06F 9/542

(57) ABSTRACT

Capabilities for resource event processing are increased at resource event processing apparatus through use of a peer-to-peer resource event processing network. The resource event processing apparatus receives an alias associated with a user of the peer-to-peer resource event processing network. In response, the resource event processing apparatus communicates a peer-to-peer resource event request to the peer-to-peer resource event network. In response to the peer-to-peer resource event network receiving and processing the request, the user’s mobile communication device receives peer-to-peer resource event acceptance request and, in response to the user providing an input to accept the peer-to-peer resource event, the mobile communication device communicates a peer-to-peer resource event confirmation to the peer-to-peer resource event network.

### FIELD OF THE INVENTION

The present invention is generally directed resource event processing and, more specifically, providing peer-to-peer resource event processing at a resource event processing apparatus.

### BACKGROUND

Resource events processed at resource event processing apparatus are typically limited in terms of the different resource event processing channels/networks that can be used to conduct a resource event. Such limitations may, in certain instances hinder or prohibit, the occurrence of a resource event.

Therefore, a need exists to develop systems, methods, computer program products and the like that provide for additional resource event processing channels/networks to be used in conjunction with resource event processing apparatus. As a result, certain resources events that would otherwise be hindered or prohibited from occurring are authorized to occur through implementation of the additional resource event processing channel/network.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program product and/or the like that increase the capabilities for resource event processing at resource event processing apparatus through use of a peer-to-peer resource event processing network.

In specific embodiments of the invention, the resource event processing apparatus receives an alias associated with a user of the peer-to-peer resource event processing network. The alias may be received by (i) capturing computer-readable indicia that, when read, identifies the alias, (ii) Near Field Communication (NFC) between the resource event processing apparatus and a mobile communication in possession of the user that stores the alias or (iii) user input of the alias at the resource event processing apparatus. In response, the resource event processing apparatus communicates a peer-to-peer resource event request to the peer-to-peer resource event network that includes the alias, identification of the entity in control of the apparatus and a resource event volume. In response the peer-to-peer resource event network receiving and processing the request, the user’s mobile communication device receives peer-to-peer resource event acceptance request and, in response to the user providing an input to accept the peer-to-peer resource event, the mobile communication device communicates a peer-to-peer resource event confirmation to the peer-to-peer resource event network. In response to the peer-to-peer resource event network receiving the peer-to-peer resource event confirmation, resources in the resource event volume are communicated to a first resource repository held by the entity and deducted from a second resource repository held by the user.

Thus, even in those incidents in which a user desires to conduct a resource event at the resource event processing apparatus but is without tangible resources or requisite card devices, the user may conduct a resource event via the resource event processing apparatus ability to communicate with the peer-to-peer resource event processing network.

A system for resource event processing defines first embodiments of the invention. The system includes a resource event processing apparatus in control of an entity. The apparatus includes a first computing platform having a first memory and one or more first computing processor devices in communication with the first memory. The first memory stores peer-to-peer resource event instructions that are executable by at least one of the first processing devices and configured to receive an alias associated with a user requesting processing of a resource event using a peer-to-peer resource event network and communicate a peer-to-peer resource event request to the peer-to-peer resource event network. The peer-to-peer resource event request includes the alias, an identifier for the entity and a resource event volume.

The system additionally includes a mobile communication device in possession of the user. The mobile communication device includes a second computing platform having a second memory and one or more second computing processor devices in communication with the second memory. The second memory stores a peer-to-peer resource event application that is executable by at least one of the second processing devices. The application is configured to, in response to the peer-to-peer resource event network receiving the peer-to-peer resource event request, receive a peer-to-peer resource event acceptance request and, in response to the user providing an input to accept the peer-to-peer resource event, communicate a peer-to-peer resource event confirmation to the peer-to-peer resource event network. In response to the peer-to-peer resource event network receiving the peer-to-peer resource event confirmation, resources in the resource event volume are communicated to a first resource repository held by the entity and deducted from a second resource repository held by the user.

In specific embodiments of the system, the peer-to-peer resource event application includes computer-readable indicia configured to be read by a computing platform to initiate the peer-to-peer resource event and identify the alias. In such embodiments of the system, the resource event processing apparatus further comprises an image-capturing device executable by at least one of the one of more computing processor devices and configured to capture the computer-readable indicia. Thus, in such embodiments of the system, the peer-to-peer resource event instructions are configured to receive the alias by reading the captured computer-readable indicia.

In other embodiments of the system, the mobile communication device includes a near-field communication (NFC) device and the resource event processing apparatus includes an NFC beacon. In such embodiments of the system, the peer-to-peer resource event instructions receives the alias by NFC communication between the NFC device and NFC beacon.

In still further specific embodiments of the system, the peer-to-peer resource event instructions receives the alias by input from a user selected from the group consisting of (i) the user and (ii) a second user associated with the entity.

In other specific embodiments of the system, the alias is chosen from the group consisting of an electronic mail (email) address and a mobile telephone number.

Additionally, in other specific embodiments of the system, the peer-to-peer resource event confirmation is configured to include the resource event volume and an identifier of the entity.

Moreover, in additional specific embodiments of the system, the resource event processing apparatus includes a display that is in communication with at least one of the one or more first computing processor devices and the first memory stores resource event prompting instructions that are executable by at least one of the one or more first processing devices. The resource event prompting instructions are to display, within the display, a prompt for the user to select between a plurality of resource event processing options, wherein the resource event processing options include a peer-to-peer resource event option. In related embodiments of the system, the peer-to-peer resource event instructions receives the alias in response to the user selecting the peer-to-peer resource event option.

A computer-implemented method for resource event processing defines second embodiments of the invention. The method is executed by one or more processing devices. The method includes receiving, at a resource event processing apparatus, an alias associated with a user requesting processing of a resource event using a peer-to-peer resource event network and communicating a peer-to-peer resource event request to the peer-to-peer resource event network. The peer-to-peer resource event request includes the alias, an identifier for the entity and a resource event volume. Further, the method includes, in response to the peer-to-peer resource event network receiving the peer-to-peer resource event request, receiving, at a mobile communication device in possession of the user, a peer-to-peer resource event acceptance request, and, in response to the user providing an input to accept the peer-to-peer resource event, communicating, to the peer-to-peer resource event network, a peer-to-peer resource event confirmation. Moreover, the method includes, in response to the peer-to-peer resource event network receiving the peer-to-peer resource event confirmation, communicating resources in the resource event volume to first resource repository held by the entity and deducting the resource event volume from a second resource repository held by the user.

In specific embodiments of the computer-implemented method, receiving the alias further includes capturing and reading, at the resource event processing apparatus, computer-readable indicia, presented by the mobile communication device, to initiate the peer-to-peer resource event and identify the alias.

In other specific embodiments of the computer-implemented method, receiving the alias further includes transmitting the alias via near-field communication (NCF) between an NFC device included within the mobile communication device and an NFC beacon on the resource event processing apparatus.

In additional specific embodiments of the computer-implemented method, receiving the alias further includes receiving a user input of the alias from a user selected from the group consisting of (i) the user and (ii) a second user associated with the entity.

In further specific embodiments of the computer-implemented method, the alias is chosen from the group consisting of an electronic mail (email) address and a mobile telephone number.

Moreover, in additional specific embodiments the computer-implemented method further includes displaying, on a display of the resource event processing apparatus, a prompt for the user to select between a plurality of resource event processing options, wherein the resource event processing options include a peer-to-peer resource event option. In such embodiments of the computer-implemented method, receiving the alias further includes receiving the alias in response to the user selecting the peer-to-peer resource event option.

A computer program product including a non-transitory computer-readable medium defines third embodiments of the invention. The computer-readable medium includes a first set of codes for causing a resource event processing apparatus to receive an alias associated with a user requesting processing of a resource event using a peer-to-peer resource event network. In addition, the computer-readable medium includes a second set of codes for causing the resource event processing apparatus to communicate a peer-to-peer resource event request to the peer-to-peer resource event network. The peer-to-peer resource event request includes the alias, an identifier for the entity and a resource event volume. Further, the computer-readable medium includes a third set of codes for causing a mobile communication device to, in response to the peer-to-peer resource event network receiving the peer-to-peer resource event request, receive a peer-to-peer resource event acceptance request. Additionally, the computer-readable medium includes a fourth set of codes for causing the mobile communication device to, in response to the user providing an input to accept the peer-to-peer resource event, communicate, to the peer-to-peer resource event network, a peer-to-peer resource event confirmation. Moreover, the computer-readable medium includes a fifth set of codes for causing the peer-to-peer resource event network to, in response receiving the peer-to-peer resource event confirmation, communicating resources in the resource event volume to first resource repository held by the entity and deducting the resource event volume from a second resource repository held by the user.

In specific embodiments of the computer program product, the first set of codes are further configured to cause the resource event processing apparatus to capture and read computer-readable indicia, presented by the mobile communication device, to initiate the peer-to-peer resource event and identify the alias.

In other specific embodiments of the computer program product, the first set of codes are further configured to cause the resource event processing apparatus to receive the alias by near-field communication (NCF) between an NFC device included within the mobile communication device and an NFC beacon on the resource event processing apparatus.

In still further specific embodiments of the computer program product, the first set of codes are further configured to cause the resource event processing apparatus to receive a user input of the alias from a user selected from the group consisting of (i) the user and (ii) a second user associated with the entity

Additionally, in other specific embodiments of the computer program product, the computer-readable medium additionally includes a sixth set of codes for causing the resource event processing to display a prompt for the user to select between a plurality of resource event processing options, wherein the resource event processing options include a peer-to-peer resource event option. In such embodiments of the computer program product, the first set of codes are further configured to cause the resource event processing apparatus to receive in response to the user selecting the peer-to-peer resource event option.

Thus, according to embodiments of the invention, which will be discussed in greater detail below, the present invention provides for increased capabilities for resource event processing at resource event processing apparatus through use of a peer-to-peer resource event processing network.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for peer-to-peer resource event processing at a resource event processing apparatus, in accordance with some embodiments of the present disclosure;

FIG. 2 is a block diagram of a resource event processing apparatus, in accordance with some embodiments of the present disclosure;

FIG. 3 is a block diagram of a mobile communication device configured to facilitate peer-to-peer resource event processing at a resource event processing apparatus, in accordance with some embodiments of the present disclosure; and

FIG. 4 is a flow diagram of a method for peer-to-peer resource event processing at a resource event processing apparatus, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed for that increase the capabilities for resource event processing at resource event processing apparatus through use of a peer-to-peer resource event processing network

In specific embodiments of the invention, the resource event processing apparatus receives an alias associated with a user of the peer-to-peer resource event processing network. The alias may be received by (i) capturing computer-readable indicia that, when read, identifies the alias, (ii) Near Field Communication (NFC) between the resource event processing apparatus and a mobile communication in possession of the user that stores the alias or (iii) user input of the alias at the resource event processing apparatus. In response, the resource event processing apparatus communicates a peer-to-peer resource event request to the peer-to-peer resource event network that includes the alias, identification of the entity in control of the apparatus and a resource event volume. In response to the peer-to-peer resource event network receiving and processing the request, the user’s mobile communication device receives peer-to-peer resource event acceptance request and, in response to the user providing an input to accept the peer-to-peer resource event, the mobile communication device communicates a peer-to-peer resource event confirmation to the peer-to-peer resource event network. In response to the peer-to-peer resource event network receiving the peer-to-peer resource event confirmation, resources in the resource event volume are communicated to a first resource repository held by the entity and deducted from a second resource repository held by the user.

In specific embodiments of the invention, in which the resource event is a purchase transaction or the like, the resource event processing apparatus is a Point-Of-Sale (POS) terminal located at a merchant site or the like. Further, the peer-to-peer resource event processing network is a peer-to-peer digital payment network. In such of the invention, the POS terminal receives an alias associated with a user of the peer-to-peer (P2P) digital payment network. The alias may be received by (i) capturing computer-readable indicia (e.g., a Quick Response (QR) code or the like) stored within a P2P payment application on a user’s/customer’s mobile communication device that, when read identifies the alias (ii) Near Field Communication (NFC) between the POS terminal and a mobile communication in possession of the user/customer that stores the alias, or (iii) user (i.e., either customer or sales associate) input of the alias at the POS terminal. In response, the POS terminal communicates a P2P payment request to the P2P payment network that includes the alias, identification of the merchant in and a payment amount. In response to the P2P payment network receiving and processing the request, the user’s mobile communication device receives a P2P payment acceptance request and, in response to the user providing an input to accept the P2P payment, the mobile communication device communicates a P2P payment confirmation to the P2P payment network. In response to the P2P payment network receiving the P2P resource event confirmation, funds in the payment amount is communicated to a first financial account held by the merchant and the funds in the payment amount are deducted from a second financial account held by the user/customer.

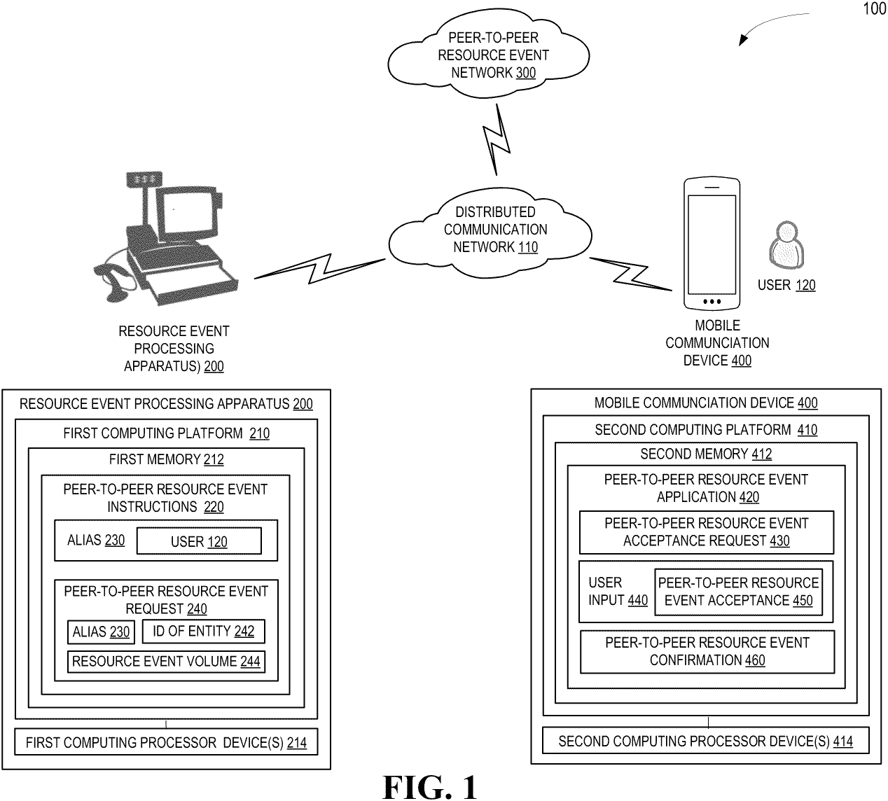

Turning now to the figures, FIG. 1 a schematic diagram is provided of a system 100 for peer-to-peer resource event processing at a resource event processing apparatus, in accordance with embodiments of the present invention. The system 100 is implemented within a distributed communication network 110, which may include the Internet, one or more intranets one or more cellular networks or the like. The system 100 includes resource event processing apparatus 210, which is controlled by an entity. In specific embodiments of the invention may comprise a point-of-sale (POS) terminal and backend network processing devices. In such embodiments of the invention, the entity may be a merchant.

Resource event processing apparatus 210 includes first computing platform 210 having first memory 212 and one or more first computing processor devices 214 in communication with first memory 212. First memory 212 stores peer-to-peer resource event instructions 220 that are executable by at least one of the first computing processor devices 214. Peer-to-peer resource event instructions 220 are configured to communicate with peer-to-peer resource even network 300 via distributed communication network 110 to initiate the processing of peer-to-peer resource events. In specific embodiments of the invention, peer-to-peer resource event instructions 220 comprise peer-to-peer payment instructions that are in communication with a peer-to-peer payment network and are configured to initiate a peer-to-peer payment between user/customer and a merchant. For purposes of the invention herein disclosed the term “peer-to-peer” (P2P) as used herein includes peer-to-business (P2B) and, thus, the peer-to-peer resource event network detailed herein may be a separate peer-to-business resource event network or the peer-to-peer resource event network may include peer-to-business resource event processing capabilities.

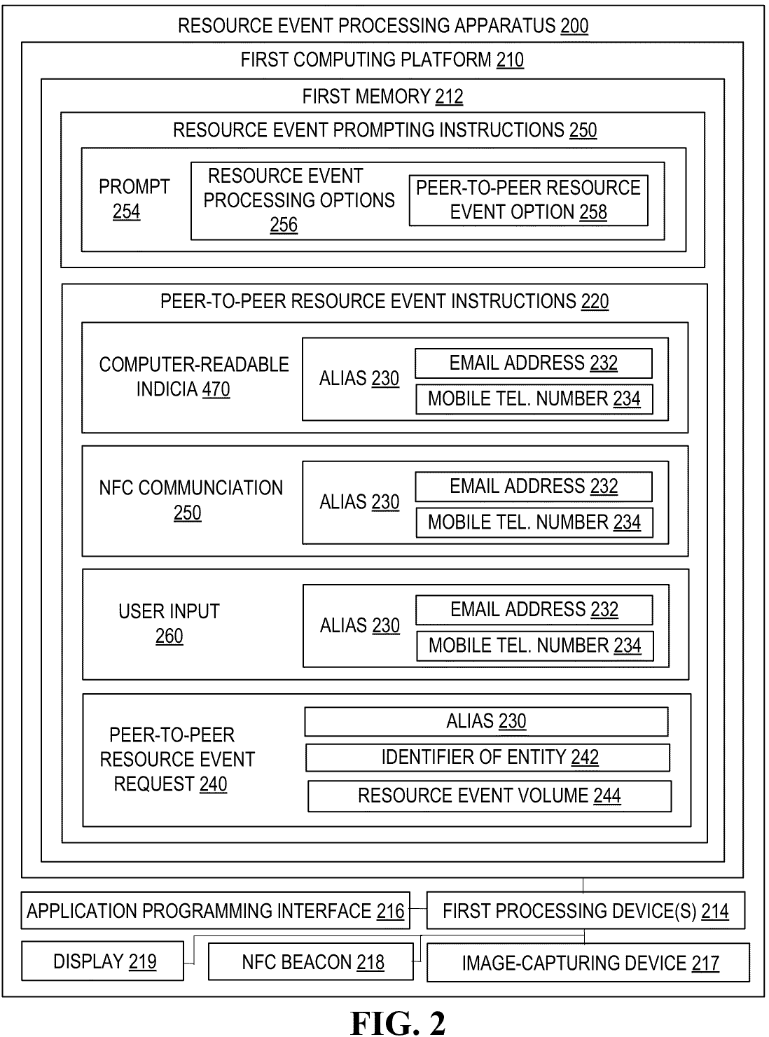

Peer-to-peer resource event instructions 220 are configured to receive an alias 230 associated with a user 120 requesting peer-to-peer resource event processing at the resource event processing apparatus 200. As described in more detail in relation to FIG. 2, the alias may be an email address, mobile telephone number or the like associated with the user 120 and may be received by the peer-to-peer resource event instructions 220 through electronic communications or manual entry by a user. In response to receiving the alias 230, peer-to-peer resource event instructions 220 are configured to generate and initiate communication of a peer-to-peer resource event request 240 to the peer-to-peer resource event network 300. The peer-to-peer resource event request includes, at the least, the alias 230, an identifier 242 of the entity in control of the resource event processing apparatus 200 and a resource event volume 244. In specific embodiments of the invention, the peer-to-peer resource event request 240 is a peer-to-peer payment request that is communicated to a peer-to-peer payment network and includes the alias of the customer, an identifier of the merchant and the payment amount.

System 100 additionally includes mobile communication device 400 that is in possession of the user 120 requesting peer-to-peer resource event processing at the resource event processing apparatus 200. Mobile communication device 400 includes second computing platform 410 having second memory 412 and one or more second computing processor devices 414. Second memory 412 stores peer-to-peer resource event application 420 that is executable by at least one of the one or more second processing devices 414. In specific embodiments of the invention, peer-to-peer resource event application is a peer-to-peer payment application, which may be a standalone application or may be included within a mobile banking application or the like.

In response to the peer-to-peer resource event network 300 receiving and processing the peer-to-peer resource event request 240, peer-to-peer resource event application 420 is configured to receive a peer-to-peer resource event acceptance request 430 communicated from the peer-to-peer resource event network 300 via distributed communication network 110. In specific embodiments of the invention, peer-to-peer resource event acceptance request 430 may take of the form of a notification/alert, a short message service (SMS)/text message or the like. The peer-to-peer resource event acceptance request 430 may be configured to include activable links for accepting and declining the peer-to-peer resource event. In response to the user 120 providing an input 440 that provides the peer-to-peer resource event acceptance 450, peer-to-peer resource event application 420 is configured to generate and initiate communication of a peer-to-peer resource event confirmation 460 to the peer-to-peer resource event network 300 via distributed communication network. In response to the peer-to-peer resource event network 300 receiving the peer-to-peer resource event confirmation 460, resources in the resource event volume 244 are communicated to a first resource depository held by the entity in control of the resource event processing apparatus 200 and deducted from a second resource repository held by the user 120. One of ordinary skill in the art will readily appreciate that processing of the peer-to-peer resource event (i.e., communication of resources to the first resource depository held by the entity and deduction of resources from the second resource repository held by the user 120) occurs in real-time with the resource event, thus incurring no delay in the availability of the resources.

In specific embodiments of the invention, in response to peer-to-peer payment network receiving and processing the peer-to-peer payment request, peer-to-peer payment application is configured to receive a peer-to-peer payment acceptance request communicated from the peer-to-peer payment network via distributed communication network 110. In response to the user 120 providing an input to accept the peer-to-peer payment, peer-to-peer payment application is further configured to generate and initiate communication of a peer-to-peer payment confirmation to the peer-to-peer payment network via distributed communication network. In response to the peer-to-peer payment network receiving the peer-to-peer payment confirmation, payment in the transaction amount are communicated to a first financial account held by the merchant and deducted from a second financial account held by the customer.

Referring to FIG. 2 a block diagram is depicted of the resource event processing apparatus 200 configured to initiate peer-to-peer resource event processing, in accordance with embodiments of the present invention. In addition to providing greater details of the resource event processing apparatus, FIG. 2 highlights various alternate embodiments of the invention. Resource event processing apparatus 200 includes first computing platform 210 which is configured to execute instructions, such as algorithms, modules, routines, applications and the like. First computing platform 210 includes first memory 212, which may comprise volatile and non-volatile memory, such as read-only and/or random-access memory (RAM and ROM), EPROM, EEPROM, flash cards, or any memory common to computing platforms). Moreover, first memory 212 may comprise cloud storage, such as provided by a cloud storage service and/or a cloud connection service.

Further, first computing platform 210 also includes at least one first processing device 214, which may be an application-specific integrated circuit (“ASIC”), or other chipset, logic circuit, or other data processing device. First processing device(s) 214 may execute one or more application programming interface (APIs) 216 that interface with any resident programs, such as peer-to-peer resource event instructions 220, resource event prompting instructions 250 or the like, stored in first memory 212 of first computing platform 210 and any external programs. First processing devices(s) 214 may include various processing subsystems (not shown in FIG. 2) embodied in hardware, firmware, software, and combinations thereof, that enable the functionality of first computing platform 210 and the operability of first computing platform 210 on the distributed computing network 110 (shown in FIG. 1). For example, processing subsystems allow for initiating and maintaining communications and exchanging data with other networked devices. For the disclosed aspects, processing subsystems of first processing device 214 may include any subsystem used in conjunction with peer-to-peer resource event instructions 220, resource event prompting instructions 250 and related tools, routines, sub-routines, algorithms, sub-algorithms, sub-modules thereof.

First computing platform 210 may additionally include a communications module (not shown in FIG. 2) embodied in hardware, firmware, software, and combinations thereof, that enables electronic communications between the computing platform 210 and other networks and network devices, such as peer-t0-peer resource event network 300 and mobile communication device 400 shown in FIG. 1. Thus, communication module may include the requisite hardware, firmware, software and/or combinations thereof for establishing and maintaining a network communication connection with one or more devices and/or networks.

Additionally, resource event processing apparatus my include one or more of image-capturing device 217, near-field communication beacon 218 and/or display 219 the functions of which will be discussed infra.

In specific embodiments of the invention, first memory 212 of first computing platform 210 stores resource event prompting instructions 250 that are executable by at least one of the one or more first computing processor devices 214 are configured to display, within display 219, a prompt 254 for the user 110 to select between one of a plurality of resource event processing options 256 including a peer-to-peer resource event option 258. In response to the user 120 selecting the peer-to-peer resource event option 250, resource event prompting instructions 250 are configured to prompt the user 110 to input or communicate their alias 230.

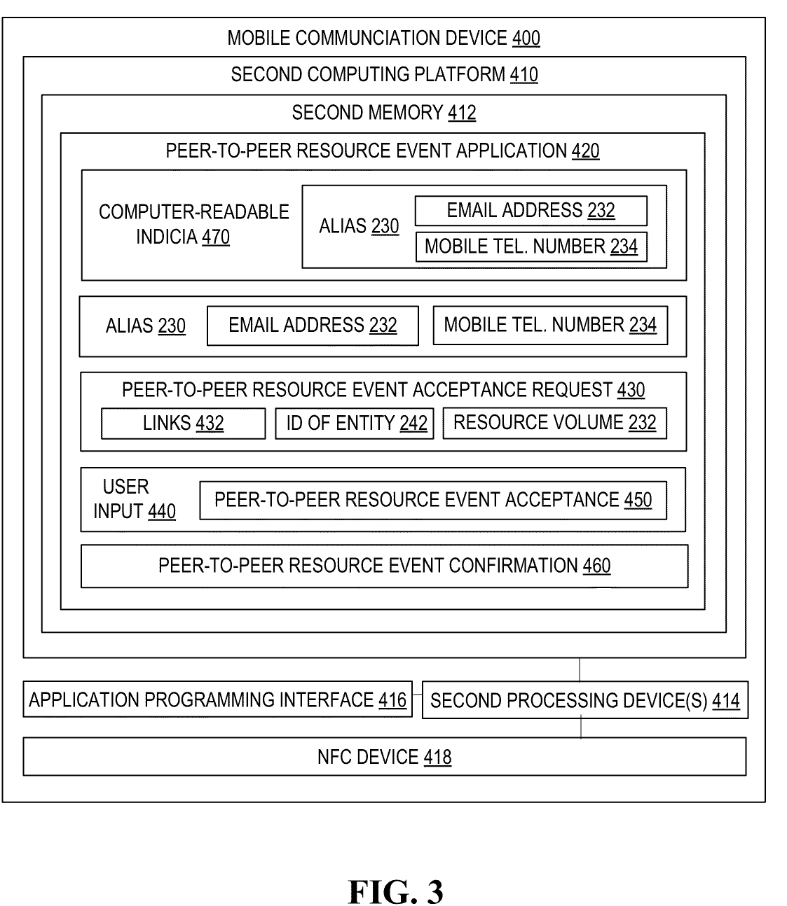

Further, first memory 212 stored peer-to-peer resource event instructions 220 that are executable by at least one of the one more first processing devices 214. Peer-to-peer resource event instructions 220 configured to receive an alias 230 associated with a user 120 requesting peer-to-peer resource event processing at the resource event processing apparatus 200. The alias 230 may be an email address 232, mobile telephone number 234 or the like associated with the user 120. In specific embodiments of the invention, the alias 230 may be received by capturing, using image-capturing device 217, computer-readable indicia 470, such as a Quick Response (QR) code or the like, from the mobile communication device 400. When read, by the instructions 220, computer-readable indicia 220 identifies the alias 230. In other embodiments of the invention, the alias 230 is received by near-field communication (NFC) beacon 218 which receives NFC communication 250, containing the alias 230, from a near-filed device 418 (see FIG. 3) included in mobile communication device 400. In still further specific embodiments of invention, the alias 230 is received by user input 250, such as user 120 or a second user associated with the entity (e.g., a merchant associate who is informed of the alias 230 by the customer).

In response to receiving the alias 230, peer-to-peer resource event instructions 220 are configured to generate and initiate communication of a peer-to-peer resource event request 240 to the peer-to-peer resource event network 300. The peer-to-peer resource event request includes, at the least, the alias 230, an identifier 242 of the entity in control of the resource event processing apparatus 200 and a resource event volume 244. In specific embodiments of the invention, the peer-to-peer resource event request 240 is a peer-to-peer payment request that is communicated to a peer-to-peer payment network and includes the alias of the customer, an identifier of the merchant and the payment amount.

Referring to FIG. 3 a block diagram is depicted of the mobile communication device 400 configured to facilitate peer-to-peer resource events at the resource processing apparatus 200, in accordance with embodiments of the present invention. The mobile communication device 400 includes second computing platform 410 which is configured to execute instructions, such as algorithms, modules, routines, applications and the like. Second computing platform 410 includes second memory 412, which may comprise volatile and non-volatile memory, such as read-only and/or random-access memory (RAM and ROM), EPROM, EEPROM, flash cards, or any memory common to computing platforms). Moreover, second memory 412 may comprise cloud storage, such as provided by a cloud storage service and/or a cloud connection service.

Further, second computing platform 410 also includes at least one second processing device 414, which may be an application-specific integrated circuit (“ASIC”), or other chipset, logic circuit, or other data processing device. Second processing device(s) 414 may execute one or more application programming interface (APIs) 416 that interface with any resident programs, such as peer-to-peer resource event application 420 or the like, stored in second memory 412 of second computing platform 410 and any external programs. Second processing devices(s) 414 may include various processing subsystems (not shown in FIG. 2) embodied in hardware, firmware, software, and combinations thereof, that enable the functionality of second computing platform 410 and the operability of second computing platform 410 on the distributed computing network 110 (shown in FIG. 1). For example, processing subsystems allow for initiating and maintaining communications and exchanging data with other networked devices. For the disclosed aspects, processing subsystems of second processing device 414 may include any subsystem used in conjunction with peer-to-peer resource event application 420 and related tools, routines, sub-routines, algorithms, sub-algorithms, sub-modules thereof.

Second computing platform 410 may additionally include a communications module (not shown in FIG. 3) embodied in hardware, firmware, software, and combinations thereof, that enables electronic communications between the computing platform 410 and other networks and network devices, such as resource event processing apparatus 200 and peer-to-peer resource event network 300 shown in FIG. 1. Thus, communication module may include the requisite hardware, firmware, software and/or combinations thereof for establishing and maintaining a network communication connection with one or more networks and/or networked devices.

Additionally, in specific embodiments of the invention mobile communication device 400 includes NFC device 418, such as an NFC integrated circuit (i.e., “chip) the functionality of which will be discussed infra.

Second memory 412 of second computing platform 410 stores peer-to-peer resource event application 420. In specific embodiments of the invention, peer-to-peer resource event application is a peer-to-peer payment application, which may be a standalone application or may be included within a mobile banking application or the like.

In specific embodiments of the invention, peer peer-to-peer resource event application 420 is configured to initiate communication of the alias 232 to the resource event processing apparatus 200. In specific embodiments of the invention, peer peer-to-peer resource event application 420 or some other application stored in the mobile communication device 400 stores computer-readable indicia 470, which may comprise a QR code or the like and, when read, identifies the alias 230, such as an email address 232 or mobile telephone number 234 associated with user 120. In such embodiments of the invention, the resource event processing apparatus 200 is equipped with an image-capturing device 217 (see, FIG. 2), such as camera, scanner or the like that is configured to capture the computer-readable indicia 470. In other embodiments of the invention, peer peer-to-peer resource event application 420 or some other application stored in the mobile communication device 400 stores the alias 230 and NFC device 418 is used to communicate the alias 230 to the resource event processing apparatus 200 when the mobile communication device 400 is within near-field range of the resource event processing apparatus 200.

In response to the peer-to-peer resource event network 300 receiving and processing the peer-to-peer resource event request 240, peer-to-peer resource event application 420 is configured to receive a peer-to-peer resource event acceptance request 430 communicated from the peer-to-peer resource event network 300 via distributed communication network 110. In specific embodiments of the invention, peer-to-peer resource event acceptance request 430 may take of the form of a notification/alert, a short message service(SMS)/text message or the like and may include activable links 432 for accepting and declining the peer-to-peer resource event, as well as, the identifier 242 of the entity in control of the resource event processing apparatus 200 and the resource event volume 232. In response to the user 120 providing a user input 440 (i.e., activating the corresponding link 432)that provides for peer-to-peer resource event acceptance 450, peer-to-peer resource event application 420 is configured to generate and initiate communication of a peer-to-peer resource event confirmation 460 to the peer-to-peer resource event network 300 via distributed communication network. In response to the peer-to-peer resource event network 300 receiving the peer-to-peer resource event confirmation 460, resources in the resource event volume 244 are communicated to a first resource depository held by the entity in control of the resource event processing apparatus 200 and deducted from a second resource repository held by the user 120. One of ordinary skill in the art will readily appreciate that processing of the peer-to-peer resource event (i.e., communication of resources to the first resource depository held by the entity and deduction of resources from the second resource repository held by the user 120) occurs in real-time with the resource event, thus incurring no delay in the availability of the resources.

In specific embodiments of the invention, in response to peer-to-peer payment network receiving and processing the peer-to-peer payment request, peer-to-peer payment application is configured to receive a peer-to-peer payment acceptance request communicated from the peer-to-peer payment network via distributed communication network 110. In response to the user 120 providing an input to accept the peer-to-peer payment, peer-to-peer payment application is further configured to generate and initiate communication of a peer-to-peer payment confirmation to the peer-to-peer payment network via distributed communication network. In response to the peer-to-peer payment network receiving the peer-to-peer payment confirmation, payment in the transaction amount are communicated to a first financial account held by the merchant and deducted from a second financial account held by the customer.

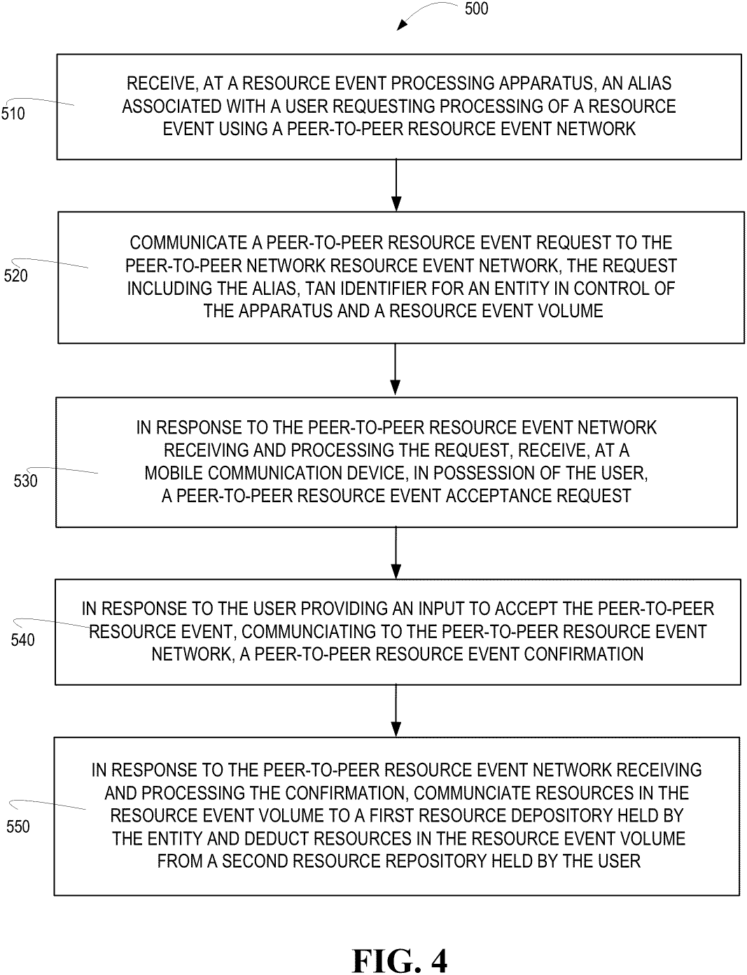

Referring to FIG. 4 a flow diagram is presented of a computer-implemented method 500 for processing peer-to-peer resource events via a resource event processing apparatus, in accordance with embodiments of the present invention. The computer-implemented method is executable by one or more processing devices which may be disposed in one or more computing platforms. At Event 510, an alias associated with a user requesting peer-to-peer resource event processing is received at a resource event processing apparatus. In specific embodiments of the invention, the alias is received by electronic communication (i.e., capturing and reading computer-readable indicia that encodes the alias from the user’s mobile communication device, near-field communication (NFC) between the resource event processing apparatus and the user’s mobile communication device or the like), while in other embodiments of the invention, the alias may be manually input by the user or another user associated with the entity controlling the resource event processing apparatus. In specific embodiments of the invention, the alias is associated with a customer requesting peer-to-peer payment processing at a POS terminal.

In response to receiving the alias, at Event 520, a peer-to-peer resource event request is communicated from the resource event processing apparatus to a peer-to-peer resource event network. The request includes, at least, the alias, an entity identifier and the resource event volume. In specific embodiments of the invention, a peer-to-peer payment request is generated and communicated from the POS terminal to a peer-to-peer payment network. The request including the alias, a merchant identifier and the payment amount.

In response to the peer-to-peer resource event network receiving and processing the peer-to-peer resource event request, at Event 530, the mobile communication device in possession of the user receives, from the network, a peer-to-peer resource event acceptance request, which may include activatable links for accepting or declining the peer-to-peer resource event and, in some embodiments, includes an entity identifier and resource event volume. In specific embodiments of the invention, in response to the peer-to-peer payment network receiving and processing the peer-to-peer payment request, the mobile communication device in possession of the customer receives, from the payment network, a peer-to-peer payment acceptance request, which may include activatable links for accepting or declining the peer-to-peer payment and, in some embodiments, includes an merchant identifier and payment amount.

In response to the user providing an input that accepts the peer-to-peer resource event, at Event 540, a peer-to-peer resource event confirmation is generated and communicated to the peer-to-peer resource event network. In specific embodiments of the invention, in response to the user providing an input that accepts the peer-to-peer payment, a peer-to-peer payment confirmation is generated and communicated to the peer-to-peer payment network.

In response to the peer-to-peer resource event network receiving and processing the confirmation, at Event 550, in real-time, resources of the resource event volume are communicated to a first resource repository held by the entity and resources of the resource event volume are deducted from a second resource repository held by the user. In specific embodiments of the invention, in response to the peer-to-peer payment network receiving and processing the confirmation, at Event 550, in real-time, funds in the payment amount are communicated/added to a first financial account held by the merchant and funds in the payment amount are deducted from a second financial account held by the customer.

Thus, present embodiments of the invention provide for the initiating peer-to-peer resource event processing at a conventional resource event processing apparatus. The resource event processing apparatus receives an alias associated with a user of the peer-to-peer resource event processing network. In response, the resource event processing apparatus communicates a peer-to-peer resource event request to the peer-to-peer resource event network. In response to the peer-to-peer resource event network receiving and processing the request, the user’s mobile communication device receives peer-to-peer resource event acceptance request and, in response to the user providing an input to accept the peer-to-peer resource event, the mobile communication device communicates a peer-to-peer resource event confirmation to the peer-to-peer resource event network.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource event processing, the system comprising:
a resource event processing apparatus in control of an entity including a first computing platform having a first memory and one or more first computing processor devices in communication with the first memory, wherein the first memory stores peer-to-peer resource event instructions that are executable by at least one of the first processing devices and configured to:
receive an alias associated with a user requesting processing of a resource event using a peer-to-peer resource event network;
communicate a peer-to-peer resource event request to the peer-to-peer resource event network, wherein the peer-to-peer resource event request includes the alias, an identifier for the entity and a resource event volume;
a mobile communication device in possession of the user and comprising a second computing platform having a second memory, and one or more second computing processor devices in communication with the second memory, wherein the second memory stores a peer-to-peer resource event application that is executable by at least one of the second processing devices and configured to:
in response to the peer-to-peer resource event network receiving the peer-to-peer resource event request, receive a peer-to-peer resource event acceptance request;
in response to the user providing an input to accept the peer-to-peer resource event, communicate a peer-to-peer resource event confirmation to the peer-to-peer resource event network,
wherein in response to the peer-to-peer resource event network receiving the peer-to-peer resource event confirmation, resources in the resource event volume are communicated to a first resource repository held by the entity and deducted from a second resource repository held by the user.

2. The system of claim 1, wherein the peer-to-peer resource event application includes computer-readable indicia configured to be read by a computing platform to initiate the peer-to-peer resource event and identify the alias.

3. The system of claim 2, wherein the resource event processing apparatus further comprises an image-capturing device executable by at least one of the one of more computing processor devices and configured to capture the computer-readable indicia, and wherein the peer-to-peer resource event instructions are configured to receive the alias by reading the captured computer-readable indicia.

4. The system of claim 1, wherein the mobile communication device includes a near-field communication (NFC) device and the resource event processing apparatus includes an NFC beacon and wherein the peer-to-peer resource event instructions receives the alias by NFC communication between the NFC device and NFC beacon.

5. The system of claim 1, wherein the peer-to-peer resource event instructions receives the alias by input from a user selected from the group consisting of the user and a second user associated with the entity.

6. The system of claim 2, wherein the alias is chosen from the group consisting of an electronic mail (email) address and a mobile telephone number.

7. The system of claim 1, wherein the resource event processing apparatus includes a display that is in communication with at least one of the one or more first computing processor devices and wherein the first memory stores resource event prompting instructions that are executable by at least one of the one or more first processing devices and configured to display, within the display, a prompt for the user to select between a plurality of resource event processing options, wherein the resource event processing options include a peer-to-peer resource event option.

8. The system of claim 8, wherein the peer-to-peer resource event instructions receives the alias in response to the user selecting the peer-to-peer resource event option.

9. The system of claim 1, wherein the peer-to-peer resource event confirmation is configured to include the resource event volume and an identifier of the entity.

10. A computer-implemented method for resource event processing, the method is executed by one or more processing devices and comprises:
receiving, at a resource event processing apparatus, an alias associated with a user requesting processing of a resource event using a peer-to-peer resource event network;
communicating a peer-to-peer resource event request to the peer-to-peer resource event network, wherein the peer-to-peer resource event request includes the alias, an identifier for an entity in control of the resource event processing apparatus, and a resource event volume;
in response to the peer-to-peer resource event network receiving the peer-to-peer resource event request, receiving, at a mobile communication device in possession of the user, a peer-to-peer resource event acceptance request;
in response to the user providing an input to accept the peer-to-peer resource event, communicating, to the peer-to-peer resource event network, a peer-to-peer resource event confirmation; and
in response to the peer-to-peer resource event network receiving the peer-to-peer resource event confirmation, communicating resources in the resource event volume to first resource repository held by the entity and deducting the resource event volume from a second resource repository held by the user.

11. The computer-implemented method of claim 10, wherein receiving the alias further comprises capturing and reading, at the resource event processing apparatus, computer-readable indicia, presented by the mobile communication device, to initiate the peer-to-peer resource event and identify the alias.

12. The computer-implemented method of claim 10, wherein receiving the alias further comprises transmitting the alias via near-field communication (NCF) between an NFC device included within the mobile communication device and an NFC beacon on the resource event processing apparatus.

13. The computer-implemented method of claim 10, wherein receiving the alias further comprises receiving a user input of the alias from a user selected from the group consisting of the user and a second user associated with the entity.

14. The computer-implemented method of claim 10, wherein the alias is chosen from the group consisting of an electronic mail (email) address and a mobile telephone number.

15. The computer-implemented method of claim 10, further comprising:
displaying, on a display of the resource event processing apparatus, a prompt for the user to select between a plurality of resource event processing options, wherein the resource event processing options include a peer-to-peer resource event option, and
wherein receiving the alias further comprises receiving the alias in response to the user selecting the peer-to-peer resource event option.

16. A computer program product comprising:
a non-transitory computer-readable medium comprising:
a first set of codes for causing a resource event processing apparatus to receive an alias associated with a user requesting processing of a resource event using a peer-to-peer resource event network;
a second set of codes for causing the resource event processing apparatus to communicate a peer-to-peer resource event request to the peer-to-peer resource event network, wherein the peer-to-peer resource event request includes the alias, an identifier for an entity in control of the resource event processing apparatus and a resource event volume;
a third set of codes for causing a mobile communication device to, in response to the peer-to-peer resource event network receiving the peer-to-peer resource event request, receive a peer-to-peer resource event acceptance request;
a fourth set of codes for causing the mobile communication device to, in response to the user providing an input to accept the peer-to-peer resource event, communicate, to the peer-to-peer resource event network, a peer-to-peer resource event confirmation; and
a fifth set of codes for causing the peer-to-peer resource event network to, in response receiving the peer-to-peer resource event confirmation, communicating resources in the resource event volume to first resource repository held by the entity and deducting the resource event volume from a second resource repository held by the user.

17. The computer program product of claim 16, wherein the first set of codes are further configured to cause the resource event processing apparatus to capture and read computer-readable indicia, presented by the mobile communication device, to initiate the peer-to-peer resource event and identify the alias.

18. The computer program product of claim 16, wherein the first set of codes are further configured to cause the resource event processing apparatus to receive the alias by near-field communication (NCF) between an NFC device included within the mobile communication device and an NFC beacon on the resource event processing apparatus.

19. The computer program product of claim 16, wherein the first set of codes are further configured to cause the resource event processing apparatus to receive a user input of the alias from a user selected from the group consisting of the user and a second user associated with the entity.

20. The computer program product of claim 16, wherein the computer-readable medium further includes:
a sixth set of codes for causing the resource event processing to display a prompt for the user to select between a plurality of resource event processing options, wherein the resource event processing options include a peer-to-peer resource event option, and
wherein the first set of codes are further configured to cause the resource event processing apparatus to receive in response to the user selecting the peer-to-peer resource event option.
